(19) United States
(12) Patent Application Publication
(10) Pub. No.: US 2013/0108931 A1
(43) Pub. Date: May 2, 2013

(54) POSITIVE ELECTRODE COMPOSITIONS USEFUL FOR ENERGY STORAGE AND OTHER APPLICATIONS; AND RELATED DEVICES

(71) Applicants: Richard Louis Hart, Broadalbin, NY (US); Michael Alan Vallance, Loudonville, NY (US); Karthick Vilapakkam Gourishankar, Bangalore (IN); Hari Nadathur Seshadri, Bangalore (IN); Anbarasan Viswanathan, Bangalore (IN)

(72) Inventors: Richard Louis Hart, Broadalbin, NY (US); Michael Alan Vallance, Loudonville, NY (US); Karthick Vilapakkam Gourishankar, Bangalore (IN); Hari Nadathur Seshadri, Bangalore (IN); Anbarasan Viswanathan, Bangalore (IN)

(73) Assignee: GENERAL ELECTRIC COMPANY, Schenectady, NY (US)

(21) Appl. No.: 13/285,804

(22) Filed: Oct. 31, 2011

(51) Int. Cl. H01M 4/40; H01M 4/133

(52) U.S. Cl. 429/231.9; 429/209; 252/182.1; 252/506; 252/512; 252/513; 252/514

(57) ABSTRACT

An embodiment of this invention is directed to a positive electrode composition that includes a first group of granules that contain about 30% by volume of at least one metal or electrically-conductive carbon, or combinations thereof; and a second group of granules that contain at least about 60% by volume of a metallic salt, and less than about 30% by volume of a metal. A porous structure based on a material that is resistant to non-passivating oxidation and alkaline electrolysis may be used in place of the second group of granules. An article that includes a positive electrode based on such a composition is also described, as well as related energy storage devices.

### BACKGROUND OF THE INVENTION

This invention relates generally to electrode compositions. In some specific embodiments, the invention relates to positive electrode compositions that can be incorporated into energy storage devices such as batteries; and uninterruptable power supply (UPS) devices.

Metal chloride batteries, especially sodium-metal chloride batteries with a molten sodium negative electrode (usually referred to as the anode) and a beta-alumina solid electrolyte, are of considerable interest for energy storage applications. In addition to the anode, the batteries include a positive electrode (usually referred to as the cathode) that supplies/receives electrons during the charge/discharge of the battery. The solid electrolyte functions as the membrane or “separator” between the anode and the cathode. When these metal chloride batteries are employed in mobile applications like hybrid locomotives or plug-in electric vehicles (PHEV), the batteries are often capable of providing power surges (high currents), during discharging of the battery. In an ideal situation, the battery power can be achieved without a significant loss in the working capacity and the cycle life of the battery.

Those familiar with these types of energy storage devices understand that the positive electrode plays a critical role in determining the power/energy characteristics of the battery, including its electrical resistance profile. Very often, the positive electrode includes multiple components, each having specific functions. For example, the positive electrode can include both an electrode material and a support structure. The electrode material functions as an electrochemical reactant, in both the oxidized and reduced state, or in any intermediate state. The support structure for the positive electrode does not undergo any significant chemical reaction during charge/discharge, but does support the electrode material during the electrochemical reaction, functioning as a surface upon which any solids may precipitate. The support structure also functions as a conductor of electrons through the cathode. In the case of sodium metal-chloride cells, the support structure for the cathode is usually formed of an electroactive metal like nickel.

The positive electrode composition also includes at least one metallic salt, e.g., an alkali metal halide, or a derivative of the halide. The presence of the alkali metal halide, such as sodium chloride, is very important to the function of the cathode. The alkali metal halide provides sodium ions to the electrolyte, thereby ensuring a desired cell (battery) capacity.

In general, the design of an efficient electrochemical device with this type of positive electrode requires a difficult balance between the function of the support structure and the function of the metallic salt. The metallic support structure provides the electronic “pathway” or framework for conductivity, while also providing some physical structure and rigidity to the electrode composition. The metallic salt is the source of the electrochemical reaction, i.e., electrical conductivity. An insufficient level of salt content would decrease the electrical capacity of the electrochemical cell, e.g., by decreasing the number of available chemical reaction sites. Conversely, an insufficient level of metallic content could decrease the long-range conductivity of the cell, e.g., by preventing the formation of a full metallic framework throughout the positive electrode. This could, in turn, lower the power density of the cell, and perhaps adversely affect the physical structure of the electrode.

In general, it's very clear that there continues to be a growing need in the art for alkali metal chloride storage devices (e.g., batteries) with higher performance profiles. As noted above, the positive electrode composition can play a very significant role in this performance. Thus, an improved balance in the metallic/salt content within the positive electrode may be an important contributor to the performance of the device.

### BRIEF DESCRIPTION OF THE INVENTION

An embodiment of this invention is directed to a positive electrode composition. The composition comprises:

a) a first group of granules (Group I) that comprises at least about 30% by volume of at least one metal or electrically-conductive carbon, or combinations thereof; and
b) (i) a second group of granules (Group II) that comprises at least about 60% by volume of a metallic salt, and less than about 30% by volume of a metal; or
   (ii) a porous structure comprising a material that is resistant to non-passivating oxidation and alkaline electrolysis.

Another embodiment of the invention relates to an article. The article can be in the form of an energy storage device or an uninterruptable power supply (UPS) device. The device includes a positive electrode that contains a composition, as set forth above, and described in more detail in the disclosure that follows.

An additional embodiment of the invention is directed to an energy storage device. The device comprises the following elements:

I) a first negative compartment comprising an alkali metal;

II) a negative electrode current collector;

III) a second compartment comprising a positive electrode composition, as described in this specification;

IV) a positive electrode current collector; and

V) a solid separator capable of transporting alkali metal ions between the first and the second compartments.

### BRIEF DESCRIPTION OF THE DRAWINGS

FIG. 1 is a schematic, cross-sectional view of a portion of an electrochemical cell for some embodiments of the present invention.

FIG. 2 is a cross-sectional view of a portion of another electrochemical cell according to embodiments of the invention.

FIG. 3 is a cross-sectional view of a portion of an electrochemical cell for additional embodiments of the invention.

FIG. 4 contains radiography images of electrochemical cells prepared according to embodiments of this invention.

FIG. 5 is a graph representing discharge time, as a function of discharge power, for electrochemical cells related to this disclosure.

FIG. 6 is a graph representing charge time, as a function of charge cycles, for electrochemical cells related to this disclosure.

### DETAILED DESCRIPTION OF THE INVENTION

Any compositional ranges disclosed herein are inclusive and combinable (e.g., ranges of “up to about 25 wt %”, or, more specifically, “about 5 wt % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. Moreover, approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

As mentioned previously, the positive electrode is usually (although not always) referred to as the cathode. For the purpose of simplicity, the term “cathode” will sometimes be used herein to designate the positive electrode. In that vein, the term “cathode composition” instead of “positive electrode composition” may also be used herein.

As stated above, the granules or particles of Group I (sometimes referred to as the “metallic granules” for simplicity) comprise at least one metal, or electrically-conductive carbon. A number of metals may be used, and non-limiting examples include titanium, vanadium, niobium, molybdenum, nickel, cobalt, chromium, copper, manganese, silver, antimony, cadmium, tin, lead, iron, or zinc. Combinations of any of these metals are also possible. In some embodiments, a suitable metal is one with an oxidation potential greater than the highest specified charge (voltage) used.

In other specific embodiments, the metal should be one that is electroactive. As used herein, an electroactive metal is one that will undergo a redox (oxidation-reduction) reaction within the voltage range typically employed for the cell or battery, i.e., usually about 1.8-3 volts. The electroactive metals that usually satisfy this criteria are titanium, vanadium, niobium, nickel, cobalt, chromium, copper, manganese, silver, antimony, cadmium, tin, lead, iron, zinc, and combinations thereof. Very often, nickel is the most preferred metal, in view of various attributes. They usually include cost, availability, the relatively high reduction potential (“redox potential”) of nickel, relative to sodium; and the relatively low solubility of the nickel cation in the reaction-catholyte. However, it may also sometimes be desirable to use an electroactive metal like nickel, in combination with a less active (and sometimes inert) metal, e.g., one or more refractory metals like tungsten or molybdenum. Usually, the metals are obtained as powders from various commercial sources.

Carbon forms that are electrically conductive are known in the art. Some are described in U.S. Pat. No. 7,858,222, which is incorporated herein by reference. As one non-limiting example, acetylene black is a form of conductive carbon black used in various electrochemical devices, and often formed by the thermal decomposition of acetylene gas. Other forms of carbon black may be used, as well as various natural or artificial graphites, as examples. In some instances, the granules of Group I may comprise electrically-conductive carbon and an inert metal such as molybdenum and/or tungsten, i.e., without any electroactive metal. However, in those instances, the electroactive metal must be present in the granules of Group II, or in the material forming the porous structure, as mentioned previously.

The size of the metallic (i.e., Group I) granules will depend on a variety of factors. They include: the particular granule composition and the size of the cathode compartment, for example. In some embodiments, the Group I granules will have an average effective diameter in the range of about 150 microns to about 3,000 microns. In other specific embodiments, the granules will have a diameter in the range of about 300 microns to about 1900 microns. Those skilled in the art will be able to determine the most effective size for a given electrode end use, based in part on the teachings herein. (As used herein, the “effective diameter” generally refers to the diameter of a sphere having the same volume as the particle being measured).

The granules of Group I comprise at least about 30% by volume of the metal (e.g., an electroactive metal) or electrically-conductive carbon. In this manner, the granules are different from most types of conventional granules that might be used in a metal chloride battery, since those granules usually contain no more than about 20% metal, by volume. As alluded to above, the higher metal content for the Group I granules can enhance the overall conductivity network and structure of the cathode. In some specific embodiments, these granules may comprise at least about 35% by volume of the metal. As further described below, the remaining content of the granules is usually some combination of porosity (e.g., about 1-30%), with perhaps one or more additives.

As mentioned previously, for some embodiments of this invention, the positive electrode includes a second group of granules, i.e., Group II. These granules comprise at least about 60% by volume of a metallic salt, and are sometimes referred to herein, for simplicity, as the “metallic salt granules”. In some specific embodiments, the granules comprise at least about 70% by volume salt. Moreover, in some other preferred embodiments, the granules comprise at least about 80% by volume salt. The Group II granules usually comprise less than about 30% by volume of a metal (e.g., an electroactive metal); and in some cases, less than about 25% of the metal. (As used herein, the metal refers to the metallic form, and not to any metal that is present in a “metallic salt”).

The higher levels of salt (i.e., above about 60% by volume) are an indication that these Group II granules are also different from most types of conventional granules, where the salt level is usually no greater than about 60% by volume. As mentioned previously, the salt-based content of the positive electrode composition is the primary source of the electrochemical reactions of the device. In this manner, the Group II granules enhance the electrical capacity of a related device, e.g., one designed for energy storage. (In some embodiments, the Group II granules may have a porosity of about 1-30%).

A variety of metallic salts may be employed. Examples include halides of sodium, potassium, or lithium. In some preferred embodiments, the composition comprises at least sodium chloride. In other embodiments, the composition comprises sodium chloride and at least one of sodium iodide and sodium fluoride. In some specific embodiments, sodium iodide, when present, is at a level of about 0.1 weight percent to about 0.9 weight percent, based on the weight of the entire positive electrode composition.

In some embodiments, the Group II granules will have an average effective diameter in the range of about 150 microns to about 3,000 microns. In other specific embodiments, the granules will have a diameter in the range of about 300 microns to about 1,900 microns. Those skilled in the art will be able to determine the most effective size for a given electrode end use, based in part on the teachings herein.

Moreover, in some embodiments, it may be advantageous for the Group I and Group II granules to have different, average particle sizes. This could, for example, improve the “packing” of the two granule types, which may improve or maintain conductivity.

The Group I granules and Group II granules may be distributed within the cathode in random fashion. For example, the granules can be pre-mixed beforehand, and simply poured into the cathode container. The actual ratio, by volume, between the two types of granules will vary, according to some of the factors discussed previously. In some embodiments, the Group I and Group II granules collectively are used in a ratio that provides an overall material composition of about 15% to about 25% by volume metal; and about 55% to about 80% by volume of the metallic salt (i.e., total salt content, if there are multiple salts). However, in some of the other embodiments, where cell power may perhaps be a greater consideration than cell energy, the ratio of Group Ito Group II granules may vary significantly. As a non-limiting example, the volume ratio of the Group I granules to Group II granules may sometimes be in the range of about 25:75 to about 90:10. Moreover, in other embodiments, the balance between the capabilities for an “ionic pathway” and a “conductive pathway” are the primary consideration. In that instance, a desirable ratio for a conductive pathway may be between about 25:75 and about 50:50. A desirable ratio for an ionic pathway may be between about 90:10 and about 50:50.

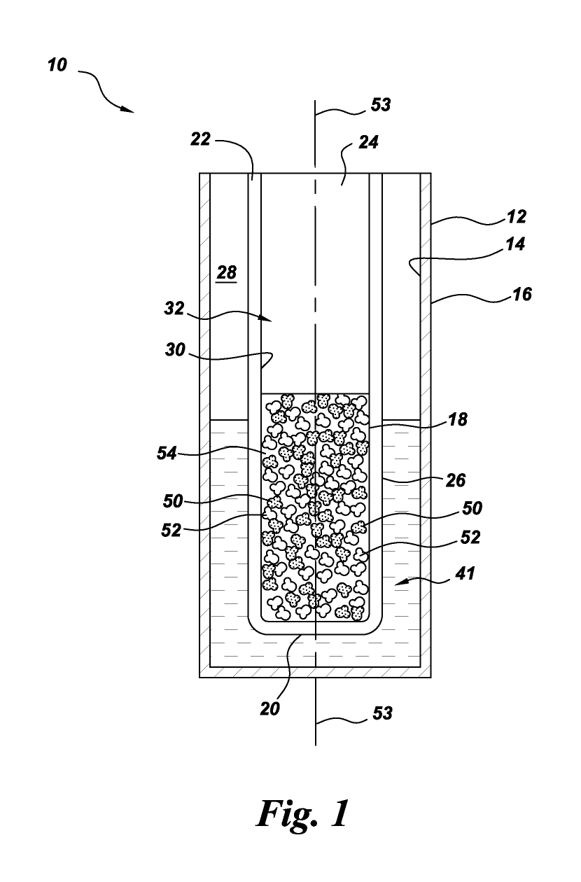

FIG. 1 provides one illustration of an electrochemical cell that includes a positive electrode composition according to embodiments of this invention. The cell 10 includes a housing 12 having an interior surface 14 that defines a volume; and has a base 16. The housing 12 may also be referred to as a “casing.” In some cases, the housing 12 may have a circular or elliptical cross-section. In other embodiments, the housing 12 may be polygonal in cross-section, and may have a plurality of corner regions. In such instances, the housing 12 of the electrochemical cell 10 may be square in cross-section, and have four corner regions.

With regard to the material, the housing 12 is generally made of a metallic material. Suitable metallic materials may include nickel, iron, or molybdenum. Specific examples may be mild steel, stainless steel, nickel-coated steel, and molybdenum-coated steel.

With continuing reference to FIG. 1, the electrochemical cell 10 includes a separator 18 disposed in the volume of the housing 12. The separator 18 is usually an ion-conducting solid electrolyte, and this feature of the device is described in various references, such as pending patent application Ser. No. 13/173320 (G. Zappi et al), which is incorporated herein by reference. Suitable materials for the separator may include beta′-alumina, beta″-alumina, beta′-gallate, beta″-gallate, or zeolite. In some specific embodiments, the separator 18 includes a beta″-alumina solid electrolyte (BASE). The separator can be characterized by a selected ionic conductivity.

In the illustrated embodiment, the separator 18 may be cylindrical, elongate, tubular, or cup-shaped, with a closed-end 20 and an open-end 22, for a cylindrical or tubular cell. In one embodiment, the separator may be substantially planar; and the corresponding cell may be a planar electrochemical cell. Referring to FIG. 1 again, the open-end 22 of the separator 18 may be sealable, and may be a part of the separator assembly that defines an aperture 24, for filling the separator 18 with a material during the manufacturing process. In one instance, the aperture 24 may be useful for adding the cathodic material, as described below. The closed-end 20 of the separator 18 may be pre-sealed, to increase the cell integrity and robustness. The separator may also have a cross-sectional profile that can be a circle, an oval or ellipse, a polygon, a cross-shape, a star shape, or a cloverleaf shape, for example. In some particular embodiments, the separator may have a cross sectional profile in the shape of a rugate, which can include a plurality of lobe portions and valley (depression) portions in an alternating pattern.

With continued reference to FIG. 1, the housing 12 is generally a container that defines an anode compartment 28 between an interior surface 14 of the housing 12, and an anode surface 26 of the separator 18. The separator 18 further has a cathode surface 30 that defines a portion of a cathode compartment 32. The cathode compartment 32 is disposed within the anode compartment 28, in these instances. Moreover, the anode compartment 28 (which contains suitable anodic material) is in ionic communication with the cathode compartment 32, through the ion-conducting separator 18. The anode compartment 28 and the cathode compartment 32 further include current collectors (e.g., positive current collector 53), to collect the current produced by the electrochemical cell. In some cases, the casing itself may serve as the anode current collector.

The cathode chamber/compartment 32 contains the positive electrode composition, as mentioned previously. (The composition can fill or partially fill the compartment, depending on cell requirements). For embodiments of this invention, the cathode chamber comprises both Group I granules 50 and Group II granules 52. In terms of drawing convention, the granules are displayed differently for ease-of-viewing, but may not be visibly different from each other, in practice. Moreover, the granules are viewed as being of similar size, but the size for the granules in each group may vary considerably from those of the other group. They are also shown as being somewhat uniformly dispersed, although that may not always be the case.

The region 54 represents the area of porosity between the granules, and is referred to herein as the “external porosity”. The external porosity can vary greatly, e.g., from about 25% to about 70%, depending on the ultimate use of the article, such as the particular application for the energy storage device. In some preferred embodiments for these situations, the external porosity is often in the range of about 30% to about 40%. (As mentioned previously, each granule may also contain some internal porosity). In preparing an electrochemical cell, both the internal and external porosity is usually filled with a liquid electrolyte, such as molten sodium aluminum chloride (NaAlCl₄). In some embodiments, the total porosity that is filled by the electrolyte may be in the range between about 30% and about 60%.

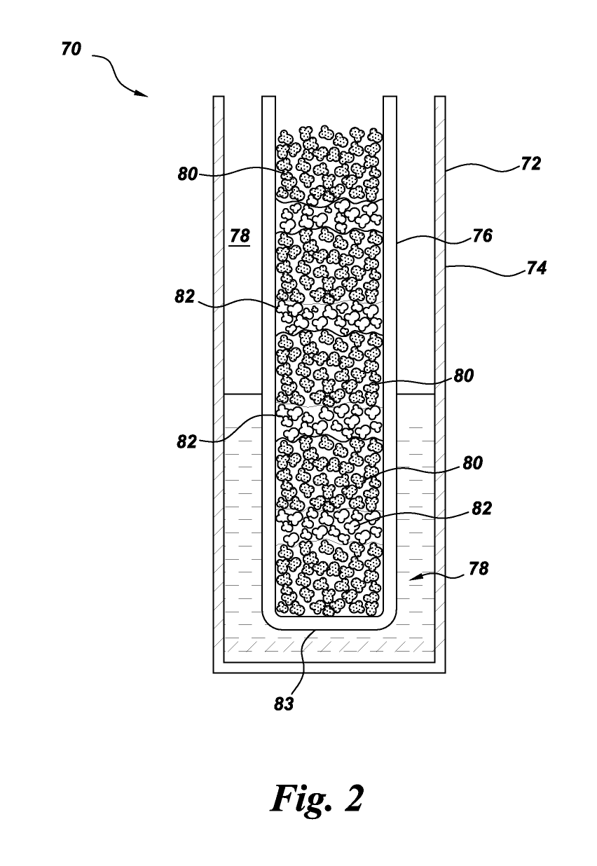

In some embodiments, the Group I granules and the Group II granules are partitioned into multiple, discrete segments adjacent to each other, within the container holding the positive electrode composition. FIG. 2 provides an illustration for some of these embodiments. (Features similar or identical to FIG. 1 may not be labeled in the figure; and in some cases (e.g., the current collectors), may be omitted for simplicity). Electrochemical cell 70 includes a separator 72 disposed in the volume of the housing 74. The separator can be in a variety of shapes, as described in reference to FIG. 1. The cathode compartment 76 (i.e., the positive electrode compartment) is disposed within the anode compartment 78.

With continuing reference to the exemplary embodiment of FIG. 2, segments 80 comprise the Group I granules, i.e., the metallic granules that comprise at least one electroactive metal, or electrically-conductive carbon. Segments 80 generally alternate with segments 82. The latter segments comprise the Group II granules, i.e., the metallic salt granules.

The size (i.e., depth) and shape of each segment can vary considerably, based on many of the factors mentioned previously. In some cases (though not all cases), the amount of material in each segment is determined by a calculation based on the desired content for the overall composition, as discussed previously. Moreover, the amount of material in each segment is often determined by the desired balance of cell capacity and cell power. When cathode compartment 76 is a generally cylindrical tube; each segment 80 and 82 may be a generally planar disc or “slice”, i.e., generally parallel with the base 83 of the cathode compartment. The disc of a particular material would contact an adjacent disc along the height of the compartment. This arrangement of alternating segments may be obtained by alternating the delivery of the two different types of granules (e.g., pouring of the granules into the compartment), during preparation of the electrochemical cell. The borders between the segments may be somewhat uneven, or can be quite uniform, depending in part on how the granules are incorporated into the compartment, and how they might be packed afterward. (For ease-of-viewing, the border-lines have been darkened somewhat).

In some embodiments (though not all), the overall content of the metallic-based Group I granules is considerably greater than the content of the salt-based Groups II granules, i.e., as shown by the thinner bands for segment 82, in the figure. In general, the exemplary arrangement depicted in FIG. 2 should provide the desired balance of metallic/salt content for a positive electrode in various applications. The desired balance is, in turn, determined by the desired long-range ionic and electronic conductivity levels for the cell.

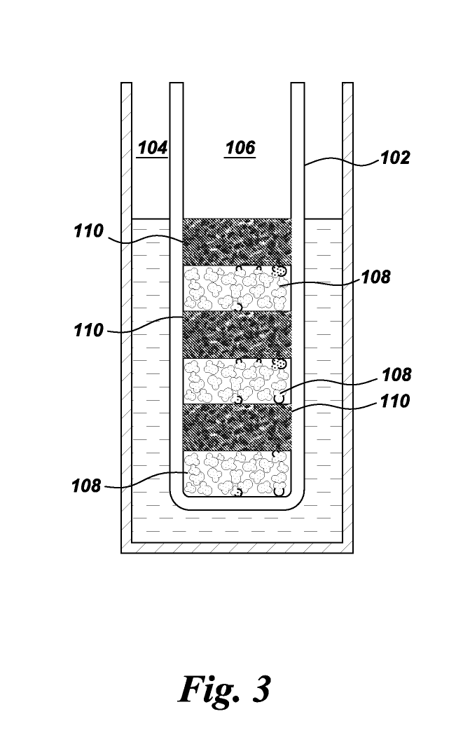

As mentioned above, the positive electrode composition may comprise a porous structure, rather than the Group II granules. FIG. 3 provides one illustration for this embodiment, with features similar or identical to FIG. 1 not being labeled, or being omitted, e.g., current collectors. Electrochemical cell 100 includes a separator 102, disposed within the anode compartment 104. The cathode compartment 106 includes the metallic granules of Group I, in segments 108, as in the other embodiments. However, instead of the Group II granules, the compartment includes a porous structure, in segments 110.

The porous structure can be formed from a variety of materials. However, it is usually important that the material be resistant to non-passivating oxidation and alkaline electrolysis. In this manner, the integrity of the material can be substantially maintained during high-temperature operation of the particular electrochemical device. Non limiting examples of suitable materials for some embodiments are metals such as nickel, tungsten, molybdenum, or various combinations thereof. (The foam usually also contains about 10% to about 30% by volume of metallic salt, based on the total volume of a particular Group II segment 110, as depicted in FIG. 3). Metal foams are available from many sources, such as Recemat International B.V. (“Open Cell Material Engineering”).

In other cases, ceramic materials could be used for the porous structure. Moreover, in some embodiments, various forms of carbon may be employed, such as carbon wool, carbon felt, or graphite felt.

In general, the porous structure can be in a variety of forms. Non-limiting examples include foam, mesh, screen, and felt. In one particular example, segments 110 comprise nickel foam, which is often a low density, permeable material. Nickel foam can be obtained commercially, from a variety of sources. It is sometimes characterized by relatively high porosity, e.g., about 70-90%. The foam structure (or other type of porous structure) for each segment can simply be inserted into place within the cathode compartment, between the steps of pouring in segments (layers) of the Group I granules.

In some instances, the porous structure can be formed by electrochemical activity in the cell. For example, in the case of metal chloride systems such as the sodium-metal chloride batteries, the discharge reaction in the cell often results in reformation of the alkali metal chloride, preferentially in or near the Group I granules, (e.g., NaCl), after having been dissolved in the charging step. This causes the Group II cathode granules to be transformed into a porous medium.

As alluded to previously, another embodiment of the invention relates to an article that includes a positive electrode composition, as described herein. As one example, the article may be in the form of an energy storage device. The device usually comprises (a) a first compartment comprising an alkali metal; (b) a second compartment including a positive electrode composition, as described herein; and (c) a solid separator capable of transporting alkali metal ions between the first and the second compartments. The working temperature of the energy storage device, when it incorporates sodium-nickel chloride cells, is usually about 250-350 degrees Celsius.

Typically, the anode compartment of the energy storage device is empty in the ground state (uncharged state) of the electrochemical cell. The anode is then filled with metal from reduced metal ions that move from the positive electrode compartment to the anode compartment through the separator, during operation of the cell. The anodic material, (e.g., sodium) is molten during use. The first compartment (usually the anode compartment) may receive and store a reservoir of anodic material.

Additives suitable for use in the anodic material may include a metallic oxygen scavenger. Suitable metal oxygen scavengers may include one or more of manganese, vanadium, zirconium, aluminum, or titanium. Other useful additives may include materials that increase wetting of the cell's separator surface, by the molten anodic material. Additionally, some additives or coatings may enhance the contact or wetting between the separator and the current collector, to ensure substantially uniform current flow throughout the separator.

Other details regarding energy storage devices suitable for embodiments of this invention are described in various references, such as those cited previously. Another example is U.S. Patent Application Publication 2011/0151289 (M. Vallance et al), which is also incorporated herein by reference. The separator, for example, can be sized and shaped to have a cross-sectional profile that is square, polygonal, circular, or clover leaf, to provide a maximum surface area for alkali metal ion transport. The separator can have a width to length ratio that is greater than about 1:10, along a vertical axis. The ionic material transported across the separator between the anode compartment and the positive electrode compartment can be an alkali metal. Suitable ionic materials may include cationic forms of one or more of sodium, lithium and potassium.

The separator may be stabilized by the addition of small amounts of a dopant. The dopant may include one or more oxides selected from lithia, magnesia, zinc oxide, and yttria. These stabilizers may be used alone or in combination with themselves, or with other materials.

Moreover, with reference to the various figures, some embodiments call for one or more shim structures to be disposed within the volume of the housing, e.g., housing 12 in FIG. 1. The shim structures support the separator within the volume of the housing. The shim structures can protect the separator from vibrations caused by the motion of the cell during use, and can thus reduce or eliminate movement of the separator relative to the housing. In one embodiment, a shim structure functions as a current collector.

A plurality of the electrochemical cells (each of which may be considered a rechargeable energy storage device) can be organized into an energy storage system, e.g., a battery. Multiple cells can be connected in series or parallel, or in a combination of series and parallel. For convenience, a group of coupled cells may be referred to as a module or pack. The ratings for the power and energy of the module may depend on such factors as the number of cells, and the connection topology in the module. Other factors may be based on end-use application specific criteria.

In some particular embodiments, the energy storage device is in the form of a battery backup system for a telecommunications (“telecom”) device, sometimes referred to as a telecommunication battery backup system (TBS). The device could be used in place of (or can complement) the well-known, valve-regulated lead-acid batteries (VRLA) that are often used in a telecommunications network environment as a backup power source. Specifications and other system and component details regarding TBS systems are provided from many sources, such as OnLine Power's “Telecommunication Battery Backup Systems (TBS)”; TBS-TBS6507A-8/3/2004 (8 pp); and “Battery Backup for Telecom: How to Integrate Design, Selection, and Maintenance”; J. Vanderhaegen; 0-7803-8458-X/04, ©2004 IEEE (pp. 345-349). Both of these references are incorporated herein by reference.

In other embodiments, the energy storage device is in the form of an uninterruptable power supply device (UPS). The primary role of most UPS devices is to provide short-term power when the input power source fails. However, most UPS units are also capable in varying degrees of correcting common utility power problems, such as those described in patent application Ser. No. 13/034,184. The general categories of modern UPS systems are on-line, line-interactive, or standby. An on-line UPS uses a “double conversion” method of accepting AC input, rectifying to DC for passing through the rechargeable battery, and then inverting back to 120V/230V AC for powering the protected equipment. A line-interactive UPS maintains the inverter in line and redirects the battery's DC current path from the normal charging mode to supplying current when power is lost. In a standby system, the load is powered directly by the input power; and the backup power circuitry is only invoked when the utility power fails. UPS systems including batteries having electrode compositions as described above may be ideal in those situations where high energy density within the battery is a requirement.

The energy storage devices illustrated herein may be rechargeable over a plurality of charge-discharge cycles. In some instances, the energy storage device may be employed in a variety of applications; and the plurality of cycles for recharge is dependent on factors such as charge and discharge current, depth of discharge, cell voltage limits, and the like.

The energy storage system described herein can usually store an amount of energy that is in a range of from about 0.1 kiloWatt hours (kWh) to about 100 kWh. An illustration can be provided for the case of a sodium-nickel chloride energy storage system (i.e., a battery) with a molten sodium anode and a beta-alumina solid electrolyte, operating within the temperature range noted above. In that instance, the energy storage system has an energy-by-weight ratio of greater than about 100 Watt-Hours per kilogram, and/or an energy-by-volume ratio of greater than about 200 Watt-Hours per liter. Another embodiment of the energy storage system has a specific power rating of greater than about 200 Watts per kilogram; and/or an energy-by-volume ratio of greater than about 500 Watt-Hours per liter. The power-to-energy ratio is usually in the range of about 1:1 hour⁻¹ to about 2:1 hour⁻¹. (It should be noted that the energy term here is defined as the product of the discharge capacity multiplied by the thermodynamic potential. The power term is defined as the power available on a constant basis, for 15 minutes of discharge, without passing through a voltage threshold sufficiently low to reduce the catholyte).

Other features associated with the energy storage system may constitute embodiments of this invention; and some are described in the referenced application Ser. No. 13/034,184. As an example, the system can include a heat management device, to maintain the temperature within specified parameters. The heat management device can warm the energy storage system if too cold, and can cool the energy storage system if too hot, to prevent an accelerated cell degradation. The heat management system includes a thaw profile that can maintain a minimal heat level in the anode and positive electrode chambers, to avoid freezing of cell reagents.

Additional embodiments of this invention are directed to an energy management system that includes a second energy storage device that differs from the first energy storage device. This dual energy storage device system can address the ratio of power to energy, in that a first energy storage device can be optimized for efficient energy storage, and the second energy storage device can be optimized for power delivery. The control system can draw from either energy storage device as needed, and charge back either energy storage device that needs such a charge.

Some of the suitable second energy storage devices, for the power platform, include a primary battery, a secondary battery, a fuel cell, and/or an ultracapacitor. A suitable secondary battery may be a lithium battery, lithium ion battery, lithium polymer battery, or a nickel metal hydride battery.

### EXAMPLES

The examples presented below are intended to be merely illustrative, and should not be construed to be any sort of limitation on the scope of the claimed invention. Unless specified otherwise, all of the components are commercially available from common chemical suppliers.

Preparation of Electrochemical Cells

A number of electrochemical cells were assembled as follows. Cylindrical separator tubes were produced according to known methods. Each tube was ceramic sodium conductive beta″-alumina. The approximate cylinder dimensions were 228 millimeters length, 36 millimeters, internal diameter, and 38 millimeters, outside diameter. Each ceramic separator tube was glass sealed to an alpha alumina collar, to form an assembly that contained both a cathode chamber and an anode chamber, as well as an attached cathode current collector. Each assembly was placed in a stainless steel housing that served as the housing to form an electrochemical cell. The housing size was about 38 millimeters×38 millimeters×230 millimeters.

Three sets of electrochemical cells were prepared, and each set included at least three individual samples. The Set 1 baseline was based on a conventional cell system, in which one type of cathode granule was used. Each granule had an approximate composition as follows, by weight:

| | | |
|---|---|---|
| NaCl | 95.82 | g |
| Nickel (Ni255) | 124.18 | g |
| Fe (<10 microns) | 6.89 | g |
| Aluminum | 1.34 | g |
| Sodium Fluoride | 3.75 | g |
| Sodium Iodide | 0.97 | g |

The granules for Set 1 had an average particle size in the range of about 0.3-1.6 mm. They were sieved prior to use, to remove any dust and stray particles.

For each of the Set 1 cells, the granules were poured into the cathode chamber, and then densified by vibration on a vibratory shaker, in a nitrogen filled glove box. The electrolyte material, molten sodium tetrachloroaluminate NaAlC₄, was then poured into the cathode chamber, under vacuum at 280 degrees Celsius. Following this, the cell cap was welded at a temperature of about 230 degrees Celsius inside the glove box, using a MaxStar Miller Welder, with an ultra-high purity argon purge. Electrodes were attached to the cells for current and other measurements. Each cell was then tested for leaks.

In terms of construction, the Set 2 electrochemical cells were substantially identical to the Set 1 cells. In this instance, however, two different types of granules were used for each cell. The Group I granules, referred to as the “high metal” or “low salt” granules, had the following composition:

| | | |
|---|---|---|
| NaCl | 29.28 | g |
| Nickel (Ni255) | 80.72 | g |
| Fe (<10 microns) | 3.45 | g |
| Aluminum | 0.67 | g |
| Sodium Fluoride | 1.88 | g |
| Sodium Iodide | 0.49 | g |

The Group II granules for Set 2, referred to as the “high salt” granules, had the following composition:

| | | |
|---|---|---|
| NaCl | 66.54 | g |
| Nickel (Ni255) | 43.46 | g |
| Fe (<10 microns) | 3.45 | g |
| Aluminum | 0.67 | g |
| Sodium Fluoride | 1.88 | g |
| Sodium Iodide | 0.49 | g |

The Group I and II granules were mixed together thoroughly. The mixture was poured into the cathode chamber, and then densified as in the case of Set 1, followed by addition of the electrolyte, as described above. The cell was then sealed and tested for leaks.

The electrochemical cells for Set 3 were also substantially identical in construction to those for the other sets. In this instance, the Group I and Group II granules were again employed, but in a segmented or layered configuration. This arrangement was accomplished by alternately pouring a portion of each composition into the cathode compartment, with a short vibration step between each poured layer, to promote settling. There were ten layers of each type of granule. As in the case of the other cells, the liquid electrolyte was then incorporated into the cell, prior to sealing and testing.

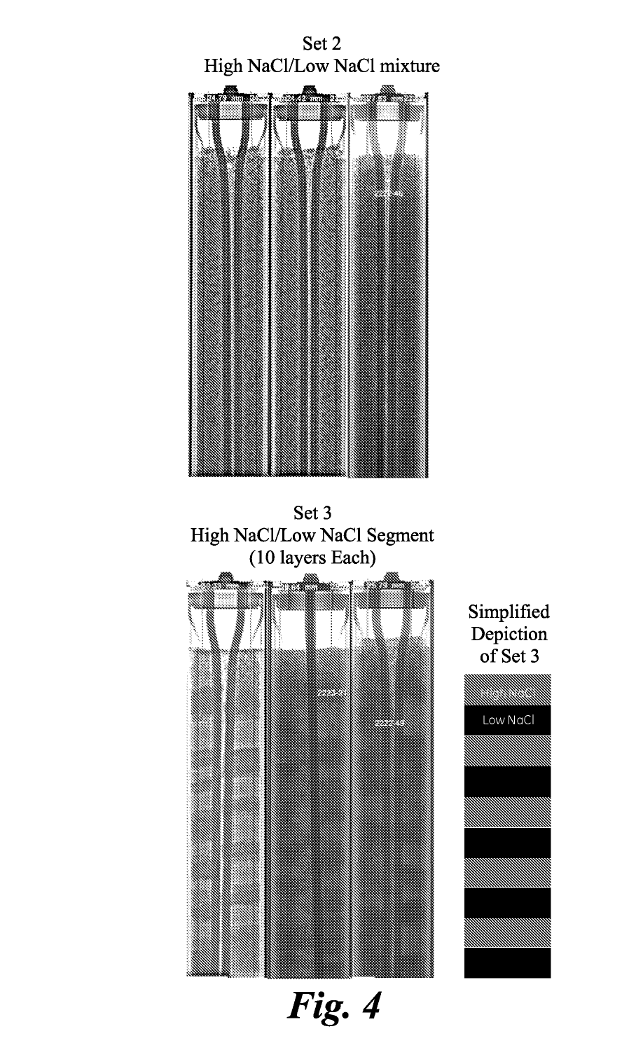

FIG. 4 provides two-dimensional radiography images for three of the Set 2 cathode compartments (left side of figure). Each of the compartments contains a substantially uniform mixture of the Group I and Group II granules. FIG. 4 also depicts the radiography-images for three of the Set 3 cathode compartments (right side of figure). Although the images are somewhat dark, the alternating segments of granules are apparent. On the far right of the figure, a simplified depiction of the alternating segments is provided, for ease-of-viewing. (The radiography images for the Set 1 (baseline) cells are not shown in the figures, but they did show a uniform distribution of the standard granules, as described above. The fill-level for the granules in the Set 1 cells was not quite as high as the level for Sets 2 or 3. This may have been due to greater settling or “packing” density, since the amount of granular material added was substantially identical to that for the other two sets).

Evaluation of Electrochemical Cells

All of the cells were assembled in the discharged state. The testing protocol for evaluation of the cells was as follows:
1. Starting at 100 mA and ramping up to 2.75 A over time, charge to 2.67V, then at 2.67V to a current of 500 mA, while at 330° C.
2. Reduce temperature to 300° C. and discharge at −16 A to 1.8V or 32 Ah.
3. Charge at 10 A to 2.67V, then at 2.67V down to 500 mA.
4. Discharge at −16 A to 1.8 V or 32 Ah.
5. Repeat steps 3 and 4 for a total of 10 cycles.
6. Charge at 15 A to 2.67V, then at 2.67V to a current of 500 mA.
7. Discharge at —60 W to 22 Ah or 1.8V.
8. Charge at 15 A to 2.67V, then at 2.67V to a current of 500 mA.
9. Discharge at —120W to 1.8V.
10. Charge at 15 A to 2.67V, then at 2.67V to a current of 500 mA.
11. Discharge at —130 W to 22 Ah or 1.8V.
12. Charge at 15 A to 2.67V, then at 2.67V to a current of 500 mA.
13. Discharge at —140 W to 22 Ah or 1.8V.
14. Charge at 15 A to 2.67V, then at 2.67V to a current of 500 mA.
15. Discharge at —155 W to 22 Ah or 1.8V.
16. Charge at 15 A to 2.67V, then at 2.67V to a current of 500 mA.
17. Discharge at —110 W to 1.8V or 15 min, then at 1.8V to 15 min.
18. Repeat steps 16 and 17 100 times.
19. Go to step 6 to repeat steps 6-18 once, for a total of 225 cycles.

Step 1 is the “maiden charge”, which starts at low current, to avoid excessive current densities during the initial production of sodium in the negative electrode. Steps 3 and 4 are mild conditioning cycles before the start of the UPS testing. Step 6 is a power-characterization start. Step 7 is a low-power cycle to measure cell resistance at deep Depths of Discharge (DoD). Steps 9, 11, 13, and 15 are high-power discharges to test the capability of the cells beyond the 110 W UPS qualification cycles. Steps 16 and 17 are the representative UPS qualification cycles. The protocol ends after 225 cycles, to maximize cell-testing throughput, while still getting enough data to make initial performance comparisons.

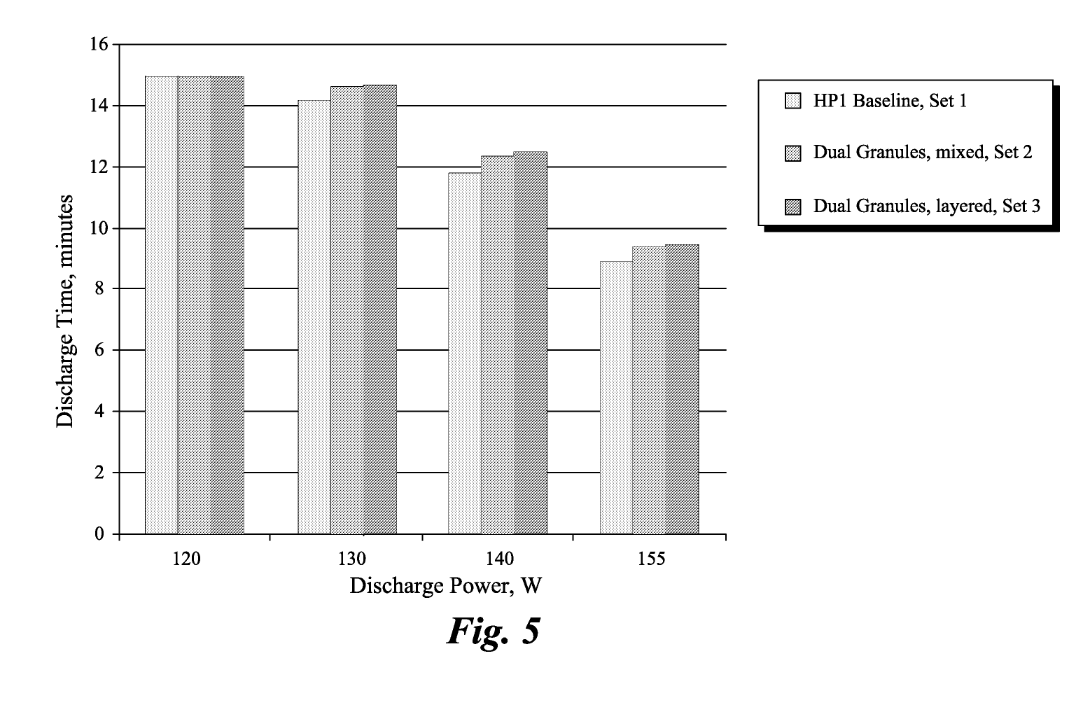

FIG. 5 is a graph representing discharge time, as a function of discharge power, after following the protocol set forth above. The data points for each of the Set 1/Set 2/Set 3 cells represented an average of three samples. The data points represent the time required to sustain the cell discharge, at a given power level. Measurements were taken at four different power levels: 120 W, 130 W, 140 W, and approximately 155 W, with each measurement point being taken after a charge-discharge cycle.

The data of FIG. 5 show all samples performing identically at the 120 watt power level. However, at the 130 watt and 140 watt power levels, both the Set 2 (mixed system) and Set 3 (segmented system) showed some improvement over the conventional Set 1 samples. In other words, the baseline samples generally reached the 1.8 voltage minimum before the other samples, indicating that the required power level could not be sustained for the full, 15 minute discharge time. The results at the 155 watt level (i.e., reviewing three individual samples) were somewhat mixed, with some baseline samples showing longer discharge time periods, as compared to some of the Set 2 and Set 3 samples. However, some improvement was in evidence here as well.

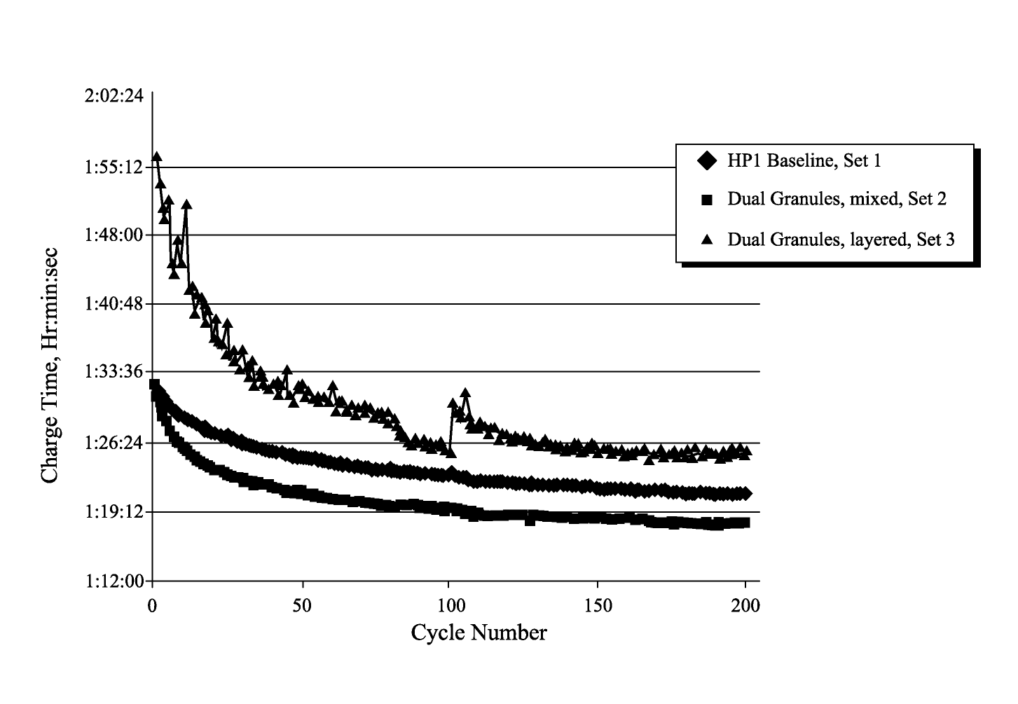

FIG. 6 is a graph representing charge time, as a function of the number of charge cycles, based in part on the protocol set forth above. The charge setting was 2.67 volts, to 0.5 amps. As described previously, the data points for each of the Set 1/Set 2/Set 3 cells represented an average of three samples. (For this type of graph, lower Y-axis values are considered to be more favorable, since they are an indication of faster charging-capability).

In general, the data of FIG. 6 demonstrate considerable advantages for the Set 2 systems, i.e., the mixed granule cathode materials, as compared to the base-line Set 1 cathode systems. The approximately 5-10 minute decrease in charge time can be a considerable advantage in an industrial setting, e.g., where UPS systems with rigorous charging requirements are required.

With continuing reference to FIG. 6, the data for the Set 3 systems, i.e., the cathodes with the segmented granules, was considerably more “scattered”. In general, the charge time values were greater than those for both the Set 1 and the Set 2 systems, indicating lower performance. Although the inventors do not want to be bound by any theory, it appears that the techniques for consistently “layering” each segment of granules within a cathode compartment may not have been optimized in these Set 3 examples.

The present invention has been described in terms of some specific embodiments. They are intended for illustration only, and should not be construed as being limiting in any way. Thus, it should be understood that modifications can be made thereto, which are within the scope of the invention and the appended claims. Furthermore, all of the patents, patent applications, articles, and texts which are mentioned above are incorporated herein by reference.

1. A positive electrode composition, comprising
a) a first group of granules (Group I) that comprises at least about 30% by volume of at least one metal or electrically-conductive carbon, or combinations thereof; and
b) (i) a second group of granules (Group II) that comprises at least about 60% by volume of a metallic salt, and less than about 30% by volume of a metal; or
(ii) a porous structure comprising a material that is resistant to non-passivating oxidation and alkaline electrolysis.

2. The composition of claim 1, wherein Group I comprises at least about 35% by volume of an electroactive metal or electrically-conductive carbon, or combinations thereof.

3. The composition of claim 1, wherein the metal for Group I is selected from the group consisting of titanium, vanadium, niobium, molybdenum, nickel, cobalt, chromium, copper, manganese, silver, antimony, cadmium, tin, lead, iron, zinc, and combinations thereof.

4. The composition of claim 1, wherein the first group of granules comprises at least one electroactive metal.

5. The composition of claim 1, wherein the metal of group 1(a) comprises nickel and at least one refractory metal.

6. The composition of claim 1, wherein the granules of Group I comprise electrically-conductive carbon and an inert metal; and the granules of Group II comprise an electroactive metal.

7. The composition of claim 1, wherein the granules of Group I have an average effective diameter in the range of about 150 microns to about 3,000 microns.

8. The composition of claim 1, wherein the second group of granules (Group II) comprises at least about 70% of the metallic salt.

9. The composition of claim 1, wherein the metallic salt comprises at least one halide of sodium, potassium, or lithium.

10. The composition of claim 9, wherein the metallic salt comprises sodium chloride.

11. The composition of claim 1, wherein the first and second groups of granules are combined in a substantially uniform distribution.

12. The composition of claim 1, wherein the first group of granules and the second group of granules collectively comprise about 15% to about 25% by volume metal and about 55% to about 80% by volume of at least one metallic salt.

13. The composition of claim 1, contained in a positive electrode compartment having a volume, wherein the Group I granules and the Group II granules are distributed within the volume, and are partitioned into multiple, discrete segments adjacent to each other.

14. The composition of claim 13, wherein the positive electrode compartment is elongated, and alternating segments of Group 1 granules and Group II granules are positioned adjacent each other, along a length of the elongated compartment.

15. The composition of claim 14, wherein the electrode compartment is generally cylindrical; and each alternating segment of granules is a generally planar disc contacting at least one adjacent, planar disc within a height dimension of the electrode compartment, so as to fill at least a portion of the volume of the compartment.

16. The composition of claim 15, wherein the Group I segments each comprise nickel; and the Group II segments each comprise sodium chloride.

17. The composition of claim 1, wherein porous structure b(ii) comprises foam, mesh, screen, or felt.

18. The composition of claim 17, wherein porous structure b(ii) comprises nickel foam.

19. An article in the form of an energy storage device or an uninterruptable power supply (UPS) device, and including a positive electrode that contains a composition comprising:
a) a first group of granules (Group I) that comprises at least about 30% by volume of at least one metal or electrically-conductive carbon, or combinations thereof; and
b) (i) a second group of granules (Group II) that comprises at least about 60% by volume of a metallic salt, and less than about 30% by volume of a metal; or
(ii) a porous structure comprising a material that is resistant to non-passivating oxidation and alkaline electrolysis.

20. An energy storage device, comprising:
I) a first negative compartment comprising an alkali metal;
II) a negative electrode current collector;
III) a second compartment comprising a positive electrode composition that itself comprises
a) a first group of granules (Group I) that comprises at least about 30% by volume of at least one metal or electrically-conductive carbon, or combinations thereof; and
b) (i) a second group of granules (Group II) that comprises at least about 60% by volume of a metallic salt, and less than about 30% by volume of a metal; or
(ii) a porous structure comprising a material that is resistant to non-passivating oxidation and alkaline electrolysis;
IV) a positive electrode current collector; and
V) a solid separator capable of transporting alkali metal ions between the first and the second compartments.
